(19) United States
(12) Patent Application Publication
(10) Pub. No.: US 2020/0288350 A1
(43) Pub. Date: Sep. 10, 2020

(54) SERVICE CONTROL APPARATUS, CHARGING MANAGEMENT SERVER, SERVICE CONTROL METHOD, CHARGING INFORMATION MANAGEMENT METHOD, AND NON-TRANSITORY COMPUTER READABLE MEDIUM

(71) Applicant: NEC Corporation, Tokyo (JP)

(72) Inventors: Toru YAMADA, Tokyo (JP); Akira KAMEI, Tokyo (JP); Yumiko OKUYAMA, Tokyo (JP); Kyoji HIRATA, Tokyo (JP); Masahiro SERIZAWA, Tokyo (JP); Satoshi HASEGAWA, Tokyo (JP); Masashi SHIMOMA, Tokyo (JP)

(73) Assignee: NEC Corporation, Tokyo (JP)

(21) Appl. No.: 16/648,516

(22) PCT Filed: May 10, 2018
(86) PCT No.: PCT/JP2018/018084

§ 371 Date: Mar. 18, 2020

(30) Foreign Application Priority Data
Sep. 21, 2017 (JP) 2017--181504

(51) Int. Cl. H04W 28/10; H04L 12/14; H04W 4/24; H04M 15/00; H04W 48/18

(52) U.S. Cl. CPC H04W 28/10; H04L 12/14; H04W 48/18; H04M 15/66; H04W 4/24

(57) ABSTRACT

A service control apparatus (20) according to the present disclosure includes: a communication unit (21) configured to receive, from each of service providing apparatuses (30, 32, 34), a communication pattern that defines a timing of communication between each of the service providing apparatuses and a communication terminal (10); and a controller (22) configured to predict a load of a network that performs data transmission between the communication terminal (10) and each of the service providing apparatuses based on the plurality of communication patterns. When it is predicted in the controller (22) that the load of the network will become higher than a predetermined threshold, the communication unit (21) transmits a message for prompting the communication pattern to change to at least one of the plurality of service providing apparatuses.

### TECHNICAL FIELD

The present disclosure relates to a service control apparatus, a charging management server, a service control method, a charging information management method, and a program.

### BACKGROUND ART

In recent years, network configurations for achieving communications between a number of Machine Type Communication (MTC) terminals connected to a network and a server apparatus have been studied by the 3rd Generation Partnership Project (3GPP). Specifically, discussions regarding an interface between a Services Capability Server (SCS) and a Service Capability Exposure Function (SCEF) entity (hereinafter, this entity is referred to as an SCEF) have been taking place. The SCS is connected to a plurality of Application Servers (ASs). The SCEF is a node arranged in a mobile network. The SCS is used as a service platform that accommodates a plurality of ASs. The mobile network is a network formed of a node apparatus whose specification is defined by the 3GPP.

Non-Patent Literature 1 defines that a T8 Reference Point is provided as an interface between the SCS and the SCEF.

Non-Patent Literature 1 defines, for example, T8 Transaction Reference ID (TTRI), T8 Long Term Transaction Reference ID (TLTRI), T8 Destination Address, Accuracy, Idle Status Indication and the like as common parameters transmitted in the T8 Reference Point.

Non-Patent Literature 1 further discloses a procedure for specifying or configuring, when the SCS performs communication with a User Equipment (UE) including an MTC terminal, communication patterns (CP) regarding the UE.

The communication patterns are defined to be CP parameters in Non-Patent Literature 1. Periodic communication indicator, Communication duration time, Periodic time, Scheduled communication time, and Stationary indication are defined as the CP parameters. Periodic communication indicator indicates whether the UE communicates periodically or only on demand. Communication duration time indicates duration interval time of periodic communication. Periodic time indicates interval time of periodic communication. Scheduled communication time indicates information regarding time when the UE is available for communication. Stationary indication indicates whether the UE performs stationary communication or mobile communication.

The SCS transmits a CP Parameter set in which at least one of Periodic communication indicator, Communication duration time, Periodic time, Scheduled communication time, and Stationary indication is configured to the SCEF via the T8 Reference Point. Next, the SCEF transmits the received CP Parameter set to a Home Subscriber Server (HSS) that manages subscriber information of the UE. The HSS manages the CP Parameter set as subscriber information of the UE. Further, the HSS transmits the CP Parameter set regarding the UE to a core network node such as a Mobile Management Entity (MME) or a Serving General Packet Radio Service Support Node (SGSN) that performs mobility management and the like of the UE.

The core network that has received the CP Parameter set communicates with the UE or executes call processing and the like for performing communication with the UE in accordance with CP Parameters included in the CP Parameter set.

### CITATION LIST

### Non-Patent Literature

[Non-Patent Literature 1] 3GPP TS23.682 V15.1.0 (2017-06)

### SUMMARY OF INVENTION

### Technical Problem

In the future, along with a rapid increase in the number of MTC terminals, it is expected that the number of MTC terminals (UEs) connected to the mobile network will be rapidly increased as well. When the number of UEs connected to the mobile network increases, the number of CP Parameter sets that the respective core network nodes hold also increases. When the core network node communicates with UE in accordance with CP Parameters, it is possible that communication timings defined by the respective CP Parameters may overlap each other. In this case, there is a problem that the greater the number of communication timings that overlap each other is, the higher the load of the core network node becomes.

An object of the present disclosure is to provide a service control apparatus, a charging management server, a service control method, a charging information management method, and a program capable of preventing the communication timings defined by the CP Parameters from overlapping each other.

### Solution to Problem

A service control apparatus according to a first aspect of the present disclosure includes: a communication unit configured to receive, from each of a plurality of service providing apparatuses, a communication pattern that defines a timing of communication between each of the service providing apparatuses and a communication terminal; and a controller configured to predict a load of a network that performs data transmission between the communication terminal and each of the service providing apparatuses based on the plurality of communication patterns, in which, when it is predicted in the controller that the load of the network will become higher than a predetermined threshold, the communication unit transmits a message for prompting the communication pattern to change to at least one of the plurality of service providing apparatuses.

A charging management server according to a second aspect of the present disclosure includes: a communication unit configured to receive, from a service control apparatus, identification information of at least one service providing apparatus whose communication pattern has been changed in accordance with a message for prompting a communication pattern to change that defines a timing of communication with a communication terminal, the at least one service providing apparatus being at least one of a plurality of service providing apparatuses that have received the message from the service control apparatus; and a controller configured to change a charging rate of the service providing apparatus specified using the identification information.

A service control method according to a third aspect of the present disclosure includes: receiving, from each of a plurality of service providing apparatuses, a communication pattern that defines a timing of communication between each of the service providing apparatuses and a communication terminal; predicting, based on the plurality of communication patterns, a load of a network that performs data transmission between the communication terminal and each of the service providing apparatuses; and transmitting, when it is predicted that the load of the network will become higher than a predetermined threshold, a message for prompting the communication pattern to change to at least one of the plurality of service providing apparatuses.

A charging information management method according to a fourth aspect of the present disclosure includes: receiving, from a service control apparatus, identification information of at least one service providing apparatus whose communication pattern has been changed in accordance with a message for prompting a communication pattern to change that defines a timing of communication with a communication terminal, the at least one service providing apparatus being at least one of a plurality of service providing apparatuses that have received the message from the service control apparatus; and changing a charging rate of the service providing apparatus specified using the identification information.

A program according to a fifth aspect of the present disclosure includes: receiving, from each of a plurality of service providing apparatuses, a communication pattern that defines a timing of communication between each of the service providing apparatuses and a communication terminal; predicting, based on the plurality of communication patterns, a load of a network that performs data transmission between the communication terminal and each of the service providing apparatuses; and transmitting, when it is predicted that the load of the network will become higher than a predetermined threshold, a message for prompting the communication pattern to change to at least one of the plurality of service providing apparatuses.

### Advantageous Effects of Invention

According to the present disclosure, it is possible to provide a service control apparatus, a charging management server, a service control method, a charging information management method, and a program capable of preventing the communication timings defined by the CP Parameters from overlapping each other.

### BRIEF DESCRIPTION OF DRAWINGS

FIG. 1 is a configuration diagram of a communication system according to a first embodiment;

FIG. 2 is a configuration diagram of a communication system according to a second embodiment;

FIG. 3 is a diagram showing a flow of CP Parameter change processing according to the second embodiment;

FIG. 4 is a configuration diagram of PCRF according to a third embodiment;

FIG. 5 is a diagram showing a flow of CP Parameter change processing according to the third embodiment; and

FIG. 6 is a configuration diagram of SCEF and PCRF according to each of the embodiments.

### DESCRIPTION OF EMBODIMENTS

### First Embodiment

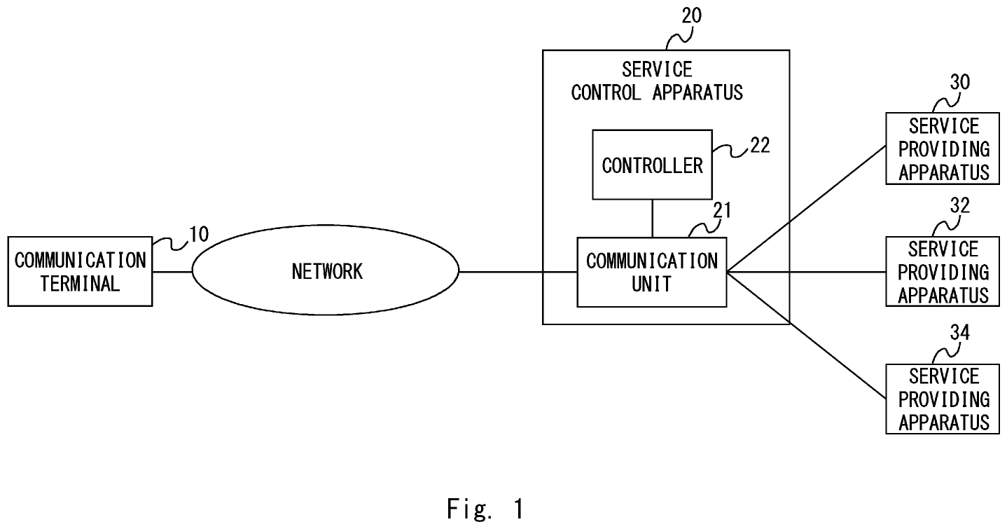

Hereinafter, with reference to the drawings, embodiments of the present disclosure will be explained. With reference to FIG. 1, a configuration example of a communication system according to a first embodiment of the present disclosure will be explained. The communication system shown in FIG. 1 includes a communication terminal 10, a service control apparatus 20, a service providing apparatus 30, a service providing apparatus 32, and a service providing apparatus 34. Further, the communication terminal 10 performs communication with the service control apparatus 20 via a network. The network includes, for example, a radio network and a core network. It is assumed that the service control apparatus 20 is arranged in a core network. Further, the network that includes the radio network and the core network may be referred to as a mobile network.

Each of the communication terminal 10, the service control apparatus 20, the service providing apparatus 30, the service providing apparatus 32, and the service providing apparatus 34 may be a computer apparatus that operates by a processor executing a program stored in a memory.

The communication terminal 10 may be a mobile telephone terminal or a smartphone terminal. Further, the communication terminal 10 may be an MTC terminal or a Machine to Machine (M2M) terminal.

Each of the service providing apparatus 30, the service providing apparatus 32, and the service providing apparatus 34 is an apparatus configured to provide communication services for the communication terminal 10 or an apparatus configured to provide communication services that use the communication terminal 10. The communication services may also be referred to as, for example, application services or the like. Each of the service providing apparatus 30, the service providing apparatus 32, and the service providing apparatus 34 may be a server apparatus that provides services.

The service control apparatus 20 is an apparatus that performs authentication processing and the like regarding the service providing apparatus 30, the service providing apparatus 32, and the service providing apparatus 34. The service control apparatus 20 may be a server apparatus that performs control regarding services provided for the communication terminal 10 or services that use the communication terminal 10. The service control apparatus 20 is arranged between the communication terminal 10, and the service providing apparatus 30, the service providing apparatus 32, and the service providing apparatus 34.

Next, a configuration example of the service control apparatus 20 will be explained. The service control apparatus 20 includes a communication unit 21 and a controller 22. Each of the communication unit 21 and the controller 22 may be software or a module whose processing is executed by a processor executing a program stored in a memory. Alternatively, each of the communication unit 21 and the controller 22 may be hardware such as a circuit or a chip.

The communication unit 21 receives information regarding communication patterns that define a timing of communication between the service providing apparatus 30 and the communication terminal 10 from the service providing apparatus 30. The communication unit 21 further receives information regarding communication patterns that define a timing of communication between the service providing apparatus 32 and the communication terminal 10 from the service providing apparatus 32. The communication unit 21 further receives information regarding communication patterns that define a timing of communication between the service providing apparatus 34 and the communication terminal 10 from the service providing apparatus 34.

The information regarding the communication patterns is information for defining a communication timing such as temporal information or time information regarding the time when the service providing apparatus 30 or the like performs communication with the communication terminal 10. The information regarding the communication patterns may be, for example, a CP Parameter set in which at least one of Communication duration time, Periodic time, and Scheduled communication time is configured.

Further, FIG. 1 shows a configuration in which the service providing apparatus 30, the service providing apparatus 32, and the service providing apparatus 34 perform communication with the communication terminal 10. Further, the service providing apparatus 30, the service providing apparatus 32, and the service providing apparatus 34 may perform communication with a communication terminal other than the communication terminal 10.

The controller 22 predicts the network load based on the communication patterns received from the service providing apparatus 30, the service providing apparatus 32, and the service providing apparatus 34. The controller 22 is able to specify, from information regarding the communication terminal of the communication destination indicated in the communication patterns received from the respective service providing apparatuses, a core network node, a radio control apparatus and the like to be used for data transmission between the communication terminal and the service providing apparatus. The core network node is a node arranged in a core network. The radio control apparatus is an apparatus that performs radio communication with the communication terminal 10 and may be, for example, a base station.

Further, the controller 22 specifies how much load concentrates in a specific core network node or radio control apparatus within a predetermined period of time from information regarding the communication timing defined by the communication patterns. For example, the controller 22 determines that the load is high when it is expected that the amount of data or the number of times of transmission of data that a specific core network node or radio control apparatus transmits within a predetermined period of time will exceed a predetermined threshold. The load in the core network node or the radio control apparatus may instead be referred to as a network load.

Further, the controller 22 may determine that the load becomes high when the communication timings defined by the communication patterns received from the service providing apparatus 30, the service providing apparatus 32, and the service providing apparatus 34 coincide with each other or are concentrated within a predetermined period. Alternatively, the controller 22 may determine that the load becomes high when the number of service providing apparatuses whose communication timings coincide with each other or when the number of service providing apparatuses that provide services intensively in a predetermined period exceed a predetermined number.

When it is determined in the controller 22 that the load of the core network node or the radio control apparatus will become high in a predetermined period, the communication unit 21 transmits a message for prompting a communication pattern to change to at least one of the service providing apparatuses 30 to 34.

The message for prompting the communication pattern to change may be, for example, a message indicating that the network load becomes high or may be a message requesting a change in the communication pattern.

Further, the controller 22 may determine the communication patterns in the respective service providing apparatuses whose network loads are low and are below a predetermined threshold. The communication unit 21 may transmit the communication pattern determined in the controller 22 to at least one of the service providing apparatus 30, the service providing apparatus 32, and the service providing apparatus 34.

As described above, the service control apparatus 20 is able to transmit, when it is estimated that the load of the network will become high, a message for prompting the communication pattern to change to at least one of the service providing apparatuses 30 to 34. When some of the service providing apparatuses that have received the message for prompting the communication pattern to change have changed the communication patterns, it is possible to prevent the load of the network from being high.

### Second Embodiment

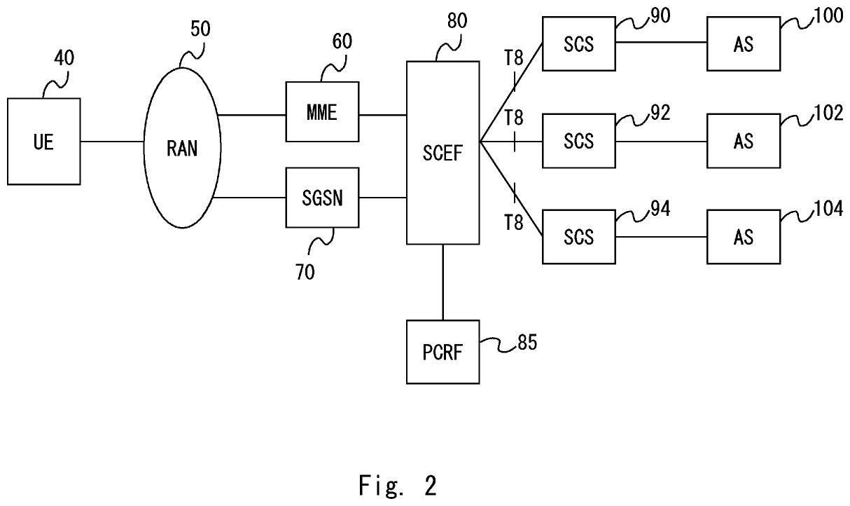

Referring next to FIG. 2, a configuration example of a communication system according to a second embodiment of the present disclosure will be explained. The communication system shown in FIG. 2 is composed of a node apparatus whose standards or specification are defined by the 3GPP. The communication system shown in FIG. 2 includes a UE 40, a Radio Access Network (RAN) 50, an MME 60, an SGSN 70, an SCEF 80, a PCRF 85, an SCS 90, an SCS 92, an SCS 94, an AS 100, an AS 102, and an AS 104. A T8 Reference Point is defined between the SCEF 80 and the SCS 90, between the SCEF 80 and the SCS 92, and between the SCEF 80 and the SCS 94.

The UE 40 corresponds to the communication terminal 10 shown in FIG. 1. The SCEF 80 corresponds to the service control apparatus 20 shown in FIG. 1. That is, the SCEF 80 has a configuration similar to that of the service control apparatus 20. The SCS 90 and the AS 100 correspond to the service providing apparatus 30 shown in FIG. 1, the SCS 92 and the AS 102 correspond to the service providing apparatus 32 shown in FIG. 1, and the SCS 94 and the AS 104 correspond to the service providing apparatus 34 shown in FIG. 1. In the following description, the SCS 90 and the AS 100, the SCS 92 and the AS 102, and the SCS 94 and the AS 104 may be described as SCS 90/AS 100, SCS 92/AS 102, and SCS 94/AS 104 as apparatuses for providing services. Further, while a configuration in which each of the SCS 90, the SCS 92, and the SCS 94 is connected to one AS is shown in FIG. 2, each of the SCSs may be connected to a plurality of ASs.

The RAN 50 may include a Radio Network Controller (RNC), a NodeB that supports so-called 2G (Generation) or 3G as a radio communication system, an evolved Node B (eNB) that supports Long Term Evolution (LTE) as a radio communication system and the like. The UE 40 performs radio communication with the Node B or the eNB. Each of the MME 60 and the SGSN 70 is a node apparatus that performs mobility management regarding the UE 40.

The PCRF 85 performs policy control in the mobile network. Further, the PCRF 85 performs charging control regarding the UE 40, the SCS 90/AS 100, the SCS 92/AS 102, and the SCS 94/AS 104. The charging control includes, for example, change in a charging rate, generation of charging information and the like.

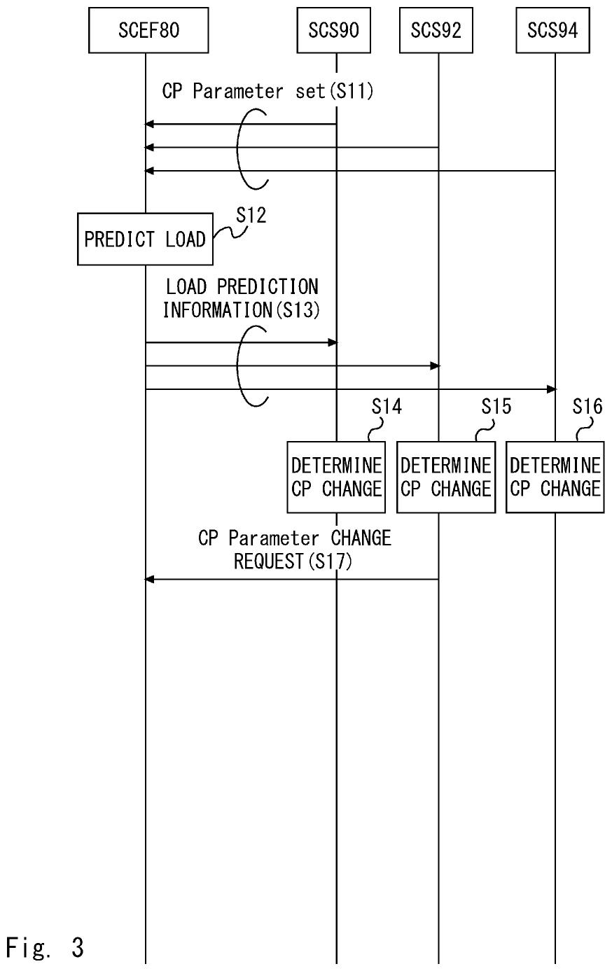

Referring next to FIG. 3, a flow of the CP Parameter change processing according to the second embodiment will be explained. First, the SCS 90 transmits a message including the CP Parameter set to the SCEF 80 (S11). Similar to the operation in the SCS 90, each of the SCS 92 and the SCS 94 also transmits a message including the CP Parameter set to the SCEF 80 (S11).

Next, the SCEF 80 predicts the network load using the CP Parameter sets received from the SCS 90, the SCS 92, and the SCS 94 (S12). The SCEF 80 may predict the network load using, for example, the CP Parameter sets received within a predetermined period of time. In other words, the SCEF 80 may predict the load of the network without using the CP Parameter sets received outside the predetermined period of time. Alternatively, the SCEF 80 may predict the network load when it has received a predetermined number of CP Parameter sets. In FIG. 3, for example, the SCEF 80 may define that the predetermined number is 3 and predict the network load in Step S12 when it receives three CP Parameter sets. Further, descriptions of S13 and the following steps will be given in FIG. 3, assuming that the SCEF 80 has predicted in Step S12 that the network load will become high.

Next, the SCEF 80 transmits a message including information indicating that the load is high to the SCS 90, the SCS 92, and the SCS 94 as load prediction information (S13). As the load prediction information, the message including information indicating that the load is high corresponds to a message for prompting the CP Parameters to change. The SCEF 80 transmits the load prediction information to the SCS 90, the SCS 92, and the SCS 94 that have transmitted the CP Parameter sets.

Next, the SCS 90, the SCS 92, and the SCS 94 that have received the load prediction information each determine whether to change the CP Parameters included in the CP Parameter set transmitted in Step S11 (S14, S15, and S16). For example, an operation in which the SCS 90 changes the CP Parameters is equal to an operation in which the SCS 90 changes the timing when the SCS 90 communicates with the UE 40. Specifically, the SCS 90 may change at least one of Communication duration time, Periodic time, and Scheduled communication time and change the communication timing in order to change the timing when the SCS 90 performs communication with the UE 40.

The SCS 90, the SCS 92, and the SCS 94 each determine whether to change the CP Parameters in accordance with a policy that each of the SCSs has such as whether the services to be provided will not be affected by the change of the CP Parameters.

In FIG. 3, descriptions will be made assuming that the SCS 92 determines that it should change the CP Parameters and the SCS 90 and the SCS 94 determine that they should not change the CP Parameters. In this case, the SCS 92 transmits a CP Parameter change request message including a CP Parameter set including CP Parameters whose values are different from those of the CP Parameters included in the CP Parameter set transmitted in Step S11 to the SCEF 80 (S17).

In the following processing, the SCEF 80 transmits the CP Parameter sets transmitted from the SCS 90, the SCS 92, and the SCS 94 to the HSS, and the HSS transmits the CP Parameter set to the MME 60 or the SGSN 70. Further, the SCEF 80 may transmit, when the processing of changing the CP Parameter set has been completed in the core network, a message indicating that the change of the CP Parameter set has been completed to the SCS 92.

As described above, the SCEF 80 according to the second embodiment is able to predict the network load using a plurality of CP Parameter sets received from the plurality of SCSs. Further, the SCEF 80 is able to transmit, when it is predicted that the network load will become high and exceed a predetermined threshold, load prediction information indicating that the network load will become high to each of the SCSs. If the SCS that has received the load prediction information has changed the CP Parameter set, it is possible to prevent that the load of the network from being high.

Further, in Step S13, the load prediction information transmitted by the SCEF 80 may include, besides prediction information indicating that the load will become high, change values of the CP Parameters. In other words, the SCEF 80 may determine the values of the CP Parameters that do not make the load of the network high and transmit the CP Parameters after the change to each of the SCSs. In other words, the SCEF 80 may determine the values of the CP Parameters so as to disperse the communication timings in order to prevent that the load of the network from being high. When the SCEF 80 has determined that the CP Parameters of only the SCS 92 among the SCS 90, the SCS 92, and the SCS 94 should be changed, the SCEF 80 may transmit the CP Parameters after the change only to the SCS 92.

Further, in order to determine the SCS whose CP Parameters should be changed, the SCEF 80 may set priorities for the SCSs in advance, and change the CP Parameters in the SCS whose priority level is low. Alternatively, the SCEF 80 may set the SCS that has transmitted the CP Parameter Set at the earliest timing to be the SCS whose CP Parameters will be changed. Alternatively, the SCEF 80 may set the SCS that has transmitted the CP Parameter set at the latest timing to be the SCS whose CP Parameters will be changed. Alternatively, the SCEF 80 may determine the SCS whose CP Parameters should be changed in accordance with the timing when the CP Parameter set has been received.

Further, when the SCS 90 and the SCS 94 have determined not to change the CP Parameters in FIG. 3, the SCS 90 and the SCS 94 may each transmit a message indicating that the change of the CP Parameters will be rejected to the SCEF 80.

### Third Embodiment

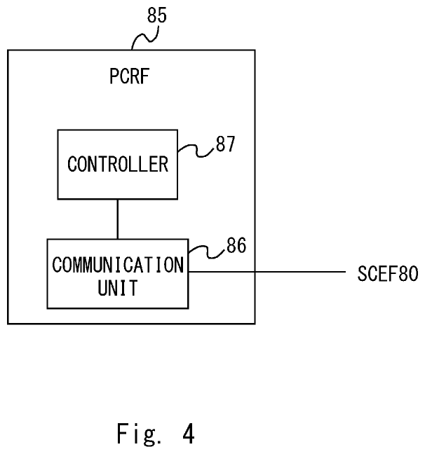

Referring next to FIG. 4, a configuration example of the PCRF 85 according to a third embodiment will be explained. The PCRF 85 includes a communication unit 86 and a controller 87. Each of the communication unit 86 and the controller 87 may be software or a module whose processing is executed by a processor executing a program stored in a memory. Alternatively, each of the communication unit 86 and the controller 87 may be hardware such as a circuit or a chip.

When at least one of the SCS 90, the SCS 92, and the SCS 94 has changed the values of the CP Parameters, the communication unit 86 receives, from the SCEF 80, identification information on the SCS whose values of the CP Parameters have been changed.

The controller 87 changes the charging rate applied to the SCS specified by the identification information received by the communication unit 86. The SCS whose values of the CP Parameters have been changed determines to change the values of the CP Parameters based on the results of the load prediction information from the SCEF 80. In other words, the SCS whose values of the CP Parameters have been changed changes the values of the CP Parameters in accordance with a request for changing the values of the CP Parameters transmitted from the communication carrier. Therefore, the communication carrier may change the charging rate of the SCS whose values of the CP Parameters have been changed so as to lower this charging rate. As described above, by performing processing of lowering the charging rate of the SCS whose values of the CP Parameters have been changed, it is possible to motivate the SCS to change the values of the CP Parameters in response to the request from the communication carrier.

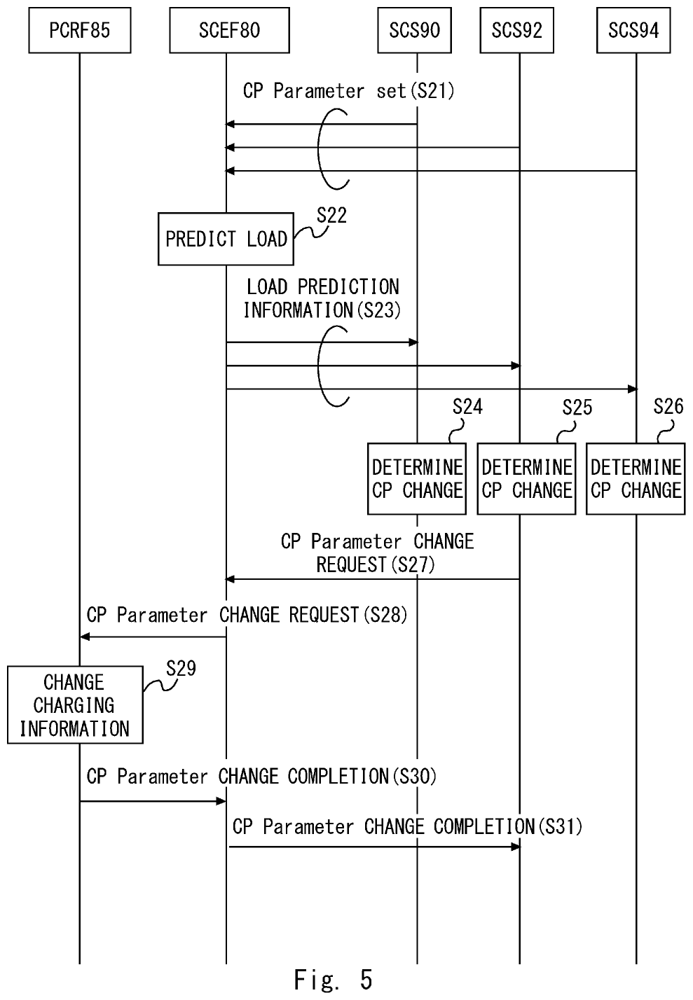

Referring next to FIG. 5, a flow of CP Parameter change processing according to the third embodiment will be explained. Since Steps S21-S27 are similar to Steps S11-S17 in FIG. 3, detailed descriptions thereof will be omitted.

When the SCEF 80 has received the CP Parameter change request message from the SCS 92 in Step S27, the SCEF 80 transmits, to the PCRF 85, a CP Parameter change request message including identification information on the SCS whose CP Parameters have been changed (S28). The identification information on the SCS may be, for example, an IP address allocated to the SCS or may be information capable of uniquely identifying the SCS in the mobile network.

Next, the PCRF 85 changes the charging information of the SCS specified by the identification information received in Step S28 (S29). Specifically, the PCRF 85 changes the charging rate of the SCS specified by the identification information received in Step S28 to lower this rate.

Next, when the change in the charging information is completed, the PCRF 85 transmits a CP Parameter change completion message to the SCEF 80 as a response to the message received in Step S28 (S30). Further, upon receiving the CP Parameter change completion message in Step S30, the SCEF 80 transmits the CP Parameter change completion message to the SCS 92 (S31).

As described above, the PCRF 85 is able to lower the charging rate of the SCS whose CP parameters have been changed in response to the request from the SCEF 80. Accordingly, it will be expected that the number of SCSs that will change the CP Parameters in response to the request for changing the CP Parameters transmitted from the SCEF 80 will increase.

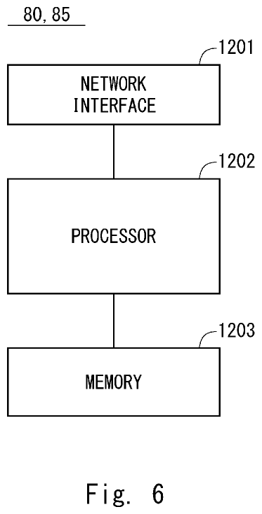

Next, in the following description, with reference to FIG. 6, a configuration example of the SCEF 80 and the PCRF 85 described in the aforementioned plurality of embodiments will be explained.

FIG. 6 is a block diagram showing a configuration example of the SCEF 80 and the PCRF 85. Referring to FIG. 6, the SCEF 80 and the PCRF 85 each include a network interface 1201, a processor 1202, and a memory 1203. The network interface 1201 is used to communicate with another network node apparatus that composes a communication system. The network interface 1201 may include, for example, a network interface card (NIC) conforming to the IEEE 802.3 series.

The processor 1202 loads software (computer programs) from the memory 1203 and executes the loaded software (computer programs) to perform processing of the SCEF 80 and the PCRF 85 described with reference to the sequence diagrams and the flowcharts in the above embodiments. The processor 1202 may be, for example, a microprocessor, a Micro Processing Unit (MPU), or a Central Processing Unit (CPU). The processor 1202 may include a plurality of processors.

The memory 1203 is composed of a combination of a volatile memory and a non-volatile memory. The memory 1203 may include a storage located apart from the processor 1202. In this case, the processor 1202 may access the memory 1203 via an I/O interface (not shown).

In the example shown in FIG. 6, the memory 1203 is used to store software modules. The processor 1202 may load these software modules from the memory 1203 and execute the loaded software modules, thereby performing the processing of the SCEF 80 and the PCRF 85 described in the above embodiments.

As described with reference to FIG. 6, each of the processors included in the SCEF 80 and the PCRF 85 executes one or more programs including instructions to cause a computer to perform an algorithm described with reference to the drawings.

In the aforementioned examples, the program(s) can be stored and provided to a computer using any type of non-transitory computer readable media. Non-transitory computer readable media include any type of tangible storage media. Examples of non-transitory computer readable media include magnetic storage media, optical magnetic storage media (e.g., magneto-optical disks), CD-Read Only Memory (CD-ROM), CD-R, CD-R/W, and semiconductor memories. The storage media include, for example, flexible disks, magnetic tapes, and hard disk drives. The semiconductor memories include, for example, mask ROM, Programmable ROM (PROM), Erasable PROM (EPROM), flash ROM, and Random Access Memory (RAM). Further, the program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present disclosure is not limited to the aforementioned embodiments and may be changed as appropriate without departing from the spirit of the present disclosure. Further, the present disclosure may be executed by combining the embodiments as appropriate.

While the present disclosure has been described with reference to the embodiments, the present disclosure is not limited to the aforementioned embodiments. Various changes that can be understood by those skilled in the art can be made to the configurations and the details of the present disclosure within the scope of the present disclosure.

This application is based upon and claims the benefit of priority from Japanese Patent Application No. 2017-181504, filed on Sep. 21, 2017, the disclosure of which is incorporated herein in its entirety by reference.

A part or all of the aforementioned embodiments may be described as shown in the following Supplementary Notes. However, they are not limited thereto.

(Supplementary Note 1)

A service control apparatus comprising:

a communication unit configured to receive, from each of a plurality of service providing apparatuses, a communication pattern that defines a timing of communication between each of the service providing apparatuses and a communication terminal; and

a controller configured to predict a load of a network that performs data transmission between the communication terminal and each of the service providing apparatuses based on the plurality of communication patterns,

wherein, when it is predicted in the controller that the load of the network will become higher than a predetermined threshold, the communication unit transmits a message for prompting the communication pattern to change to at least one of the plurality of service providing apparatuses.

(Supplementary Note 2)

The service control apparatus according to Supplementary Note 1, wherein the communication unit transmits information indicating a communication pattern after the change to the service providing apparatus as the message for prompting the communication pattern to change.

(Supplementary Note 3)

The service control apparatus according to Supplementary Note 2, wherein the communication pattern after the change changes at least one of duration time of periodic communication with the communication terminal, a time interval of the periodic communication, and time when communication with the communication terminal is available.

(Supplementary Note 4)

The service control apparatus according to Supplementary Note 2 or 3, wherein the controller determines the communication pattern after the change in such a way that the timing of communication between each of the service providing apparatuses and the communication terminal is dispersed.

(Supplementary Note 5)

The service control apparatus according to any one of Supplementary Notes 1 to 4, wherein, when at least one of the service providing apparatuses has changed the communication pattern, the communication unit transmits, to a charging management server that manages a charging rate regarding the plurality of service providing apparatuses, identification information of the service providing apparatus whose communication pattern has been changed.

(Supplementary Note 6)

A charging management server comprising:

a communication unit configured to receive, from a service control apparatus, identification information of at least one service providing apparatus whose communication pattern has been changed in accordance with a message for prompting a communication pattern to change that defines a timing of communication with a communication terminal, the at least one service providing apparatus being at least one of a plurality of service providing apparatuses that have received the message from the service control apparatus; and

a controller configured to change a charging rate of the service providing apparatus specified using the identification information.

(Supplementary Note 7)

A service control method comprising:

receiving, from each of a plurality of service providing apparatuses, a communication pattern that defines a timing of communication between each of the service providing apparatuses and a communication terminal;

predicting, based on the plurality of communication patterns, a load of a network that performs data transmission between the communication terminal and each of the service providing apparatuses; and

transmitting, when it is predicted that the load of the network will become higher than a predetermined threshold, a message for prompting the communication pattern to change to at least one of the plurality of service providing apparatuses.

(Supplementary Note 8)

A charging information management method comprising: receiving, from a service control apparatus, identification information of at least one service providing apparatus whose communication pattern has been changed in accordance with a message for prompting a communication pattern to change that defines a timing of communication with a communication terminal, the at least one service providing apparatus being at least one of a plurality of service providing apparatuses that have received the message from the service control apparatus; and

changing a charging rate of the service providing apparatus specified using the identification information.

(Supplementary Note 9)

A program for causing a computer to execute the following processing of:

receiving, from each of a plurality of service providing apparatuses, a communication pattern that defines a timing of communication between each of the service providing apparatuses and a communication terminal;

predicting, based on the plurality of communication patterns, a load of a network that performs data transmission between the communication terminal and each of the service providing apparatuses; and

transmitting, when it is predicted that the load of the network will become higher than a predetermined threshold, a message for prompting the communication pattern to change to at least one of the plurality of service providing apparatuses.

(Supplementary Note 10)

A program for causing a computer to execute the following processing of:

receiving, from a service control apparatus, identification information of at least one service providing apparatus whose communication pattern has been changed in accordance with a message for prompting a communication pattern to change that defines a timing of communication with a communication terminal, the at least one service providing apparatus being at least one of a plurality of service providing apparatuses that have received the message from the service control apparatus; and

changing a charging rate of the service providing apparatus specified using the identification information.

### REFERENCE SIGNS LIST

10 Communication Terminal
20 Service Control Apparatus
21 Communication Unit
22 Controller
30 Service Providing Apparatus
32 Service Providing Apparatus
34 Service Providing Apparatus
40 UE
50 RAN
60 MME
70 SGSN
80 SCEF
85 PCRF
86 Communication Unit
87 Controller
90 SCS
92 SCS
94 SCS
100 AS
102 AS
104 AS

1. A service control apparatus comprising:
at least one memory storing instructions, and
at least one processor configured to execute the instructions to;
receive, from each of a plurality of service providing apparatuses, a communication pattern that defines a timing of communication between each of the service providing apparatuses and a communication terminal;
predict a load of a network that performs data transmission between the communication terminal and each of the service providing apparatuses based on the plurality of communication patterns; and
when it is predicted that the load of the network will become higher than a predetermined threshold, transmit a message for prompting the communication pattern to change to at least one of the plurality of service providing apparatuses.

2. The service control apparatus according to claim 1, wherein the at least one processor is further configured to execute the instructions to transmit information indicating a communication pattern after the change to the service providing apparatus as the message for prompting the communication pattern to change.

3. The service control apparatus according to claim 2, wherein the communication pattern after the change changes at least one of duration time of periodic communication with the communication terminal, a time interval of the periodic communication, and time when communication with the communication terminal is available.

4. The service control apparatus according to claim 2, wherein the at least one processor is further configured to execute the instructions to determine the communication pattern after the change in such a way that the timing of communication between each of the service providing apparatuses and the communication terminal is dispersed.

5. The service control apparatus according to claim 1, wherein the at least one processor is further configured to execute the instructions to, when at least one of the service providing apparatuses has changed the communication pattern, transmit, transmit, to a charging management server that manages a charging rate regarding the plurality of service providing apparatuses, identification information of the service providing apparatus whose communication pattern has been changed.

6. A charging management server comprising:
at least one memory storing instructions, and
at least one processor configured to execute the instructions to;
receive, from a service control apparatus, identification information of at least one service providing apparatus whose communication pattern has been changed in accordance with a message for prompting a communication pattern to change that defines a timing of communication with a communication terminal, the at least one service providing apparatus being at least one of a plurality of service providing apparatuses that have received the message from the service control apparatus; and
change a charging rate of the service providing apparatus specified using the identification information.

7. A service control method comprising:
receiving, from each of a plurality of service providing apparatuses, a communication pattern that defines a timing of communication between each of the service providing apparatuses and a communication terminal;
predicting, based on the plurality of communication patterns, a load of a network that performs data transmission between the communication terminal and each of the service providing apparatuses; and
transmitting, when it is predicted that the load of the network will become higher than a predetermined threshold, a message for prompting the communication pattern to change to at least one of the plurality of service providing apparatuses.

8-10. (canceled)
